(19) United States
(12) Patent Application Publication
(10) Pub. No.: US 2016/0277491 A1
(43) Pub. Date: Sep. 22, 2016

(54) DETERMINING P2P NETWORK PERFORMANCE

(71) Applicant: Hive Streaming AB, Stockholm (SE)

(72) Inventors: Mohammed El-Beltagy, Stockholm (SE); Magnus Hedbeck, Stockholm (SE)

(21) Appl. No.: 15/073,834

(22) Filed: Mar. 18, 2016

(30) Foreign Application Priority Data
Mar. 18, 2015 (SE) 1550324-6

(51) Int. Cl. H04L 29/08; H04L 12/24

(52) U.S. Cl. CPC H04L 67/1042; H04L 41/12; H04L 41/08

(57) ABSTRACT

A device and a method performed by the device for determining performance of a peer-to-peer (P2P) network. Performance of a P2P network including a plurality of peer devices may be determined by initiating distribution of content to at least one of the plurality of peer devices in the P2P network, the distribution of content being specified by at least one distribution parameter, acquiring, from the at least one peer device, at least one metric associated with the content received by the at least one peer device, and determining the performance of the P2P network based on the acquired at least one metric.

This application claims priority to and the benefit of Swedish Application 1550324-6, filed on Mar. 18, 2015, which is incorporated herein by reference.

### TECHNICAL FIELD

The invention relates to a device and a method performed by the device for determining performance of a peer-to-peer network. The invention further relates to a computer program performing the method according to the present invention, and a computer program product comprising computer readable medium having the computer program embodied therein.

### BACKGROUND

In state of the art peer-to-peer (P2P) content distribution systems, evaluation of system performance is carried out only after an actual content distribution event has taken place. Hence, evaluating and refining the end user experience would require that a significant number of end users actively participate in a number of content distribution events, which is often not feasible. Typical user behaviour is such that after having had a less satisfactory experience of a P2P content distribution event, the user is less likely to want to take part in future events. If a system operator collects data from a small sample of target users, it may be hard to draw general conclusions on system performance.

An example of such a situation may arise in the context of live streaming of a popular event for mass consumption (e.g. a popular sports event). In such a scenario, the end users may be subject to a variety of constraining factors that affects their individual experience and overall system performance. Examples of such factors include upload and download bandwidth capabilities, different types of connectivity constraints such as Network Address Translation (NAT) issues, different video rendering capabilities due to e.g. processor performance and load, etc. Additionally, constraints may exist in the physical network, such as P2P connectivity constraints, minimum P2P delay, maximal bandwidth on a P2P link, network congestion, packet loss, etc. All of these static and dynamic factors, taken alone or in combination, may have a very dramatic effect on the performance of the P2P system. Typically, most sophisticated P2P systems have a number of parameters that may be optimally tuned for a given set of performance-constraining factors.

### SUMMARY

An object is to solve, or at least mitigate, this problem in the art and to provide an improved method of evaluating performance of a P2P network.

This object is attained in a first aspect of the present invention by a method of determining performance of a P2P network comprising a plurality of peer devices. The method comprises initiating distribution of content to at least one of the plurality of peer devices in the P2P network, the distribution of content being specified by at least one distribution parameter. The method further comprises acquiring, from the at least one peer device, at least one metric associated with the content received by the at least one peer device, and determining the performance of the P2P network based on the acquired at least one metric.

This object is attained in a second aspect of the present invention by a device configured to determine performance of a P2P network comprising a plurality of peer devices, the device comprising a processing unit being arranged to execute instructions, whereby the device is operative to initiate distribution of content to at least one of the plurality of peer devices in the P2P network, the distribution of content being specified by at least one distribution parameter. The device is further operative to acquire, from the at least one peer device, at least one metric associated with the content received by the at least one peer device, and to determine the performance of the P2P network based on the acquired at least one metric.

Thus, an evaluation process is advantageously provided for evaluating, and optionally for subsequently tuning, parameters of the P2P content distribution network in order to increase the network performance. In the P2P content distribution network, being for instance a live streaming P2P network or a video on demand (VOD) P2P network, a device according to the invention referred to as a Remote Testing (RT) server initiates distribution of content to one or more of the peer devices in the P2P network, by instructing the peer device(s) to download the content from a content distribution source such as e.g. a single streaming source or a content distribution network (CDN), or one or more neighbouring peer devices. Typically, to able to perform an adequate evaluation of the P2P network performance, data of a great number of peers is collected and evaluated.

The RT server initiates the distribution of the content from a content distribution source to each peer based on one or more distribution parameters including e.g. quality of the distributed content (particularly important in case of distributed video or audio data and commonly expressed in terms of bit rates), a download locality parameter specifying likelihood that a given peer will download the content from a proximate neighbouring peer, maximum allowable hop count of a peer from the content distribution source, etc.

The content is, as previously mentioned, requested by the peers from an appropriate source, CDN or neighbouring peer and is subsequently received at the peers, which determines one or more metrics to be associated with the received content, for instance locality of uploading peer, video playback quality, failed uploads, failed downloads, etc. The metrics are thereafter provided to the RT server for evaluation. Any network parameter can practically be envisaged for evaluation.

Based on these acquired metrics, the RT server determines the performance of the P2P network in terms of for example savings of the content distribution source, average latency, maximum latency, etc.

Advantageously, the evaluation of the P2P network performance as performed by the RT server can remotely and silently call upon existing peers to run a content distribution event using a number of tuneable distribution parameters and evaluate the performance of the network based on a number of metrics as measured by the peers.

In a further embodiment of the present invention, subsequent to the evaluation of the P2P network performance, the RT server creates one or more modified distribution parameters based on the determined performance, and initiates a further round of distribution of content to the peers based on the modified distribution parameter(s). Advantageously, by evaluating the P2P network performance based on the metrics measured by the peers, the distribution parameters may be tuned by the RT server to accomplish a desired P2P network performance. In order to accomplish the desired P2P network performance, the RT server will create one or more modified distribution parameters accordingly and initiate a further round of content distribution based on the modified parameters. Again, the peers will be instructed to request content based on the modified parameters, receive the content accordingly, measure and report the metric, and the RT server will again advantageously determine the P2P performance as brought about by the content distributed as specified by the modified distribution parameters. Thus, with this further iteration (and possibly even further iterations) where content distribution is initiated based on modified distribution parameters, an optimization procedure is performed for the tuneable distribution parameters of the P2P network. Advantageously, after having performed a number of iterations, the so called Pareto frontier of the network may be found.

Advantageously, with the method and device according to the present invention, performance of a P2P content distribution system can be evaluated in a manner that does not require active participation of the end users of the system. Hence, a system operator is allowed to better understand the expected performance of the P2P content distribution system. Such evaluation would allow the operators to adapt their P2P content distribution strategy to existing static and dynamic conditions for maximum robustness.

In an embodiment, from a distributor of the content, at least one metric associated with the content transmitted by said distributor of the content is acquired, and the performance of the P2P network is further determined based on the acquired at least one metric associated with the content transmitted.

In a further embodiment, the at least one metric associated with the content received by the at least one peer device indicates a latency between an instant of time when said content was made available at a source of the content and an instant of time when said content is received at the at least one peer device, wherein the performance of the P2P network is determined based on the latency.

In still a further embodiment, the at least one metric associated with the content received by the at least one peer device indicating the instant of time when the content is received, and the at least one metric associated with the content transmitted by the distributor of the content indicating an instant of time when said content was made available at the source of the content, wherein the performance of the P2P network is determined based on the latency.

Further provided is a computer program for causing a device to perform the method according to the present invention, and a computer program product comprising computer readable medium having the computer program embodied thereon.

Preferred embodiments of the present invention will be discussed in the following.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 illustrates a P2P network implementing a device for determining P2P network performance according to an embodiment of the present invention;

FIG. 2 shows a timing diagram illustrating a method of determining performance of the network illustrated in FIG. 1 according to an embodiment of the present invention;

FIG. 3 illustrates a prior art P2P network with a single tree overlay;

FIG. 4 shows a timing diagram illustrating a method of determining performance of the network according to another embodiment of the present invention;

FIG. 5 shows a timing diagram illustrating a method of determining performance of the network according to another embodiment of the present invention;

FIG. 6 shows a timing diagram illustrating a method of determining performance of the network according to another embodiment of the present invention; and

FIG. 7 illustrates a P2P network implementing a device for determining P2P network performance according to a further embodiment of the present invention.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

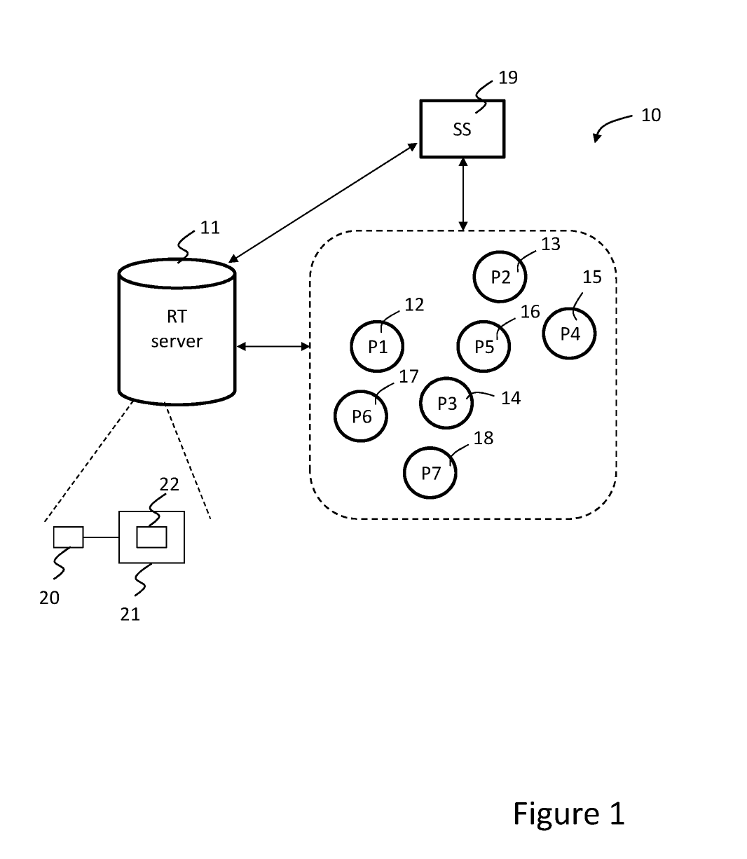

FIG. 1 illustrates a P2P network 10 in which a device 11 according to an embodiment of the present invention is implemented for determining performance of the P2P network 10. The device 11 will in the following be referred to as a Remote Testing (RT) server, and is typically located remotely from peers 12-18 of the P2P network 10. Further illustrated is a content distribution server 19 for distributing content to the peers 12-18. This will in the following be referred to as a streaming source (SS). It should be noted that a real P2P network may include hundreds or even thousands of peer devices. It should further be noted that while the RT server 11 is illustrated as being implemented in a single node, an RT system comprising a plurality of nodes may be envisaged, which plurality of nodes upon intercommunication provide the functionality of the RT server.

In practice, the method for determining performance of the P2P network 10 according to an embodiment of the present invention undertaken by RT server 11 is performed by a processing unit 20 embodied in the form of one or more microprocessors arranged to execute a computer program 22 downloaded to a suitable storage medium 21 associated with the microprocessor, such as a Random Access Memory (RAM), a Flash memory or a hard disk drive. The processing unit 20 is arranged to carry out the method according to embodiments of the present invention when the appropriate computer program 22 comprising computer-executable instructions is downloaded to the storage medium 21 and executed by the processing unit 20. The storage medium 21 may also be a computer program product comprising the computer program 22. Alternatively, the computer program 22 may be transferred to the storage medium 21 by means of a suitable computer program product, such as a Digital Versatile Disc (DVD) or a memory stick. As a further alternative, the computer program 22 may be downloaded to the storage medium 21 over a network. The processing unit 20 may alternatively be embodied in the form of a digital signal processor (DSP), an application specific integrated circuit (ASIC), a field-programmable gate array (FPGA), a complex programmable logic device (CPLD), etc. In case of a distributed RT system as mentioned in the above, each of the plurality of nodes of the system may comprise a processing unit.

In the following, timing diagrams will be employed to illustrate various embodiments of the invention. In the diagrams, signalling is undertaken in a few steps for illustrative purposes. However, in practice, signalling in a P2P system is generally extensive and highly sophisticated with many rounds of communication occurring.

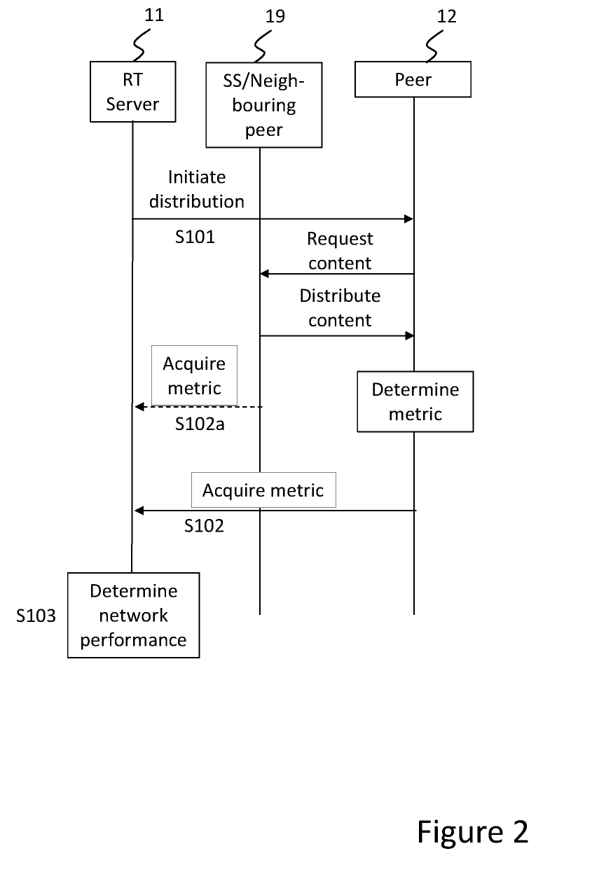

FIG. 2 shows a timing diagram illustrating a method of determining performance of the network 10 illustrated in FIG. 1 according to an embodiment of the present invention. In a practical situation, communication would typically take place between the RT server 11 and a large number of network peers in order to adequately determine performance of the P2P network 10 on the basis of measured data from a great number of peers. The measured data of the respective peer may be evaluated by the RT server 11 separately and/or in combination by aggregating measured data from a plurality of peers. However, in the timing diagram of FIG. 2, the method is illustrated by means of communication with a single peer 12.

In a first step S101, the RT server 11 initiates distribution of content to the peer 12 in the P2P network 10 by instructing the peer 12 to download the content from the streaming source 19 or, more likely due to the nature of a P2P network, from any one of the neighbouring peers 13-18, the distribution of content being specified by one or more distribution parameters determined the RT server 11. Generally, a set of distribution parameters are utilized to control the distribution of content to the network peers 12-18. Thus, the peer 12 sends a request to the streaming source 19 or a neighbouring peer 13-18 to distribute content, which distributes the content to the peer 12 as specified by the distribution parameters submitted by the RT server 11 along with the instruction to the peer 12 to request content.

In this particular embodiment, the RT server 11 and the content distribution server 19 are separate nodes. However, it can be envisaged that the RT server 11 is integrated with the content distribution server 19, thus forming a single node.

The content to be distributed may be embodied e.g. in the form of a simulated—or real—live streaming event with one or many specified bit rates (i.e. the same content may have to be streamed with different degrees of quality), as stipulated by the set of distribution parameters. As an example, for video distribution the specified bit rate may be 1.8 Mbps for full high-definition (HD) and 0.8 Mbps for standard HD. The same live streaming event may implement one of the above two bit rates, both, or further bit rates depending on application.

As an alternative, the content to be distributed may be embodied in the form of a real or simulated VOD streaming event with same or more specified bit rates. Further distribution parameters may comprise, as previously discussed, e.g. maximum allowable hop count of a peer from the content distribution source.

In a second step S102, the RT server 11 acquires from the peer 12, either by receiving or actively fetching, at least one metric associated with the content received by the peer 12. For instance, the network peers may measure and report metrics with a time resolution ranging from a few seconds to a minute or more. The metrics may for example comprise one or more of amount of data downloaded from streaming source versus amount of data downloaded from neighbouring peers in the P2P network, quality of video stream, number of hops away from the streaming source, playback point at the peer with respect the real-time playback point of the streaming source (to be used for calculating latency), etc.

In step S103, the RT server 11 evaluates the performance of the P2P network 10 based on the acquired one or more metrics from the peer 12. For instance, network performance may be determined by the RT server 11 in the form of bandwidth savings, latency of received content, quality of the content, etc.

In a further embodiment, not only will the RT server 11 acquire, from the peer 12, at least one metric associated with the content received by the peer 12, but also at least one metric associated with the content transmitted as illustrated in step S102a, such as e.g. number of bytes uploaded, failed connections, failed uploads, upload data rate, etc., from the streaming source 19, a neighbouring peer 13, or whoever is the distributor of the content. By further taking into account one or more metrics associated with the content transmitted, even further aspects of the performance of the P2P network may be determined.

In such further embodiment, the RT server 11 evaluates the performance of the P2P network 10 in step S103 based on the acquired one or more metrics associated with content received by the peer 12 as well as on the acquired one or more metrics associated with content transmitted by the streaming source 19 or a neighbouring peer 13.

As previously mentioned, it should further be noted that while the method of determining performance of the network illustrated in FIG. 2 is illustrated as being implemented in a single node, an RT system comprising a plurality of nodes or modules may be envisaged, which plurality of nodes upon intercommunication provide the functionality of the RT server. Hence, a first node may perform the step of S101 of initiating distribution of content to the peer 12, while a second node may acquire the metric from the peer 12 in step S102, and a third node evaluates the performance of the P2P network 10 based on the acquired metrics from the peer 12. Thereby, a distributed system is provided, where the various nodes may be located remotely from each other, even in different parts of the world. This may require intercommunication between one or more the first, second and third nodes. Further, each one of the nodes may comprise a processing unit executing appropriate software for providing said functionality.

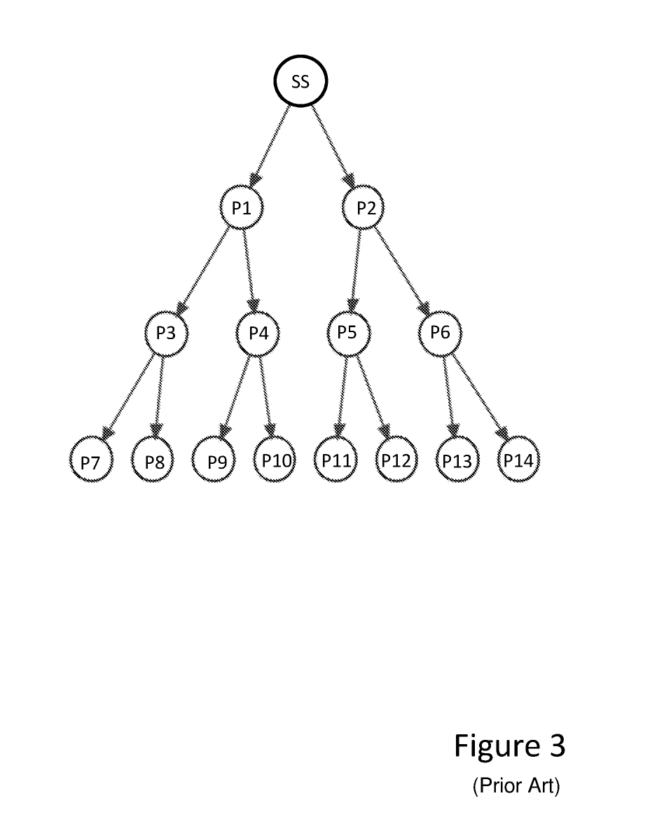

With reference to FIG. 3, an embodiment where the RT server 11 evaluates P2P network performance in the form of bandwidth savings will be discussed, even though a great number of properties stipulating network performance may be evaluated, either separately or in combination.

FIG. 3 exemplifies a prior art P2P network with a single tree overlay. This is for illustrative purposes only; it should be noted that the present invention just as well may be implemented in a multi-tree and mesh-type overlays. As can be seen, peers (in practice peer devices such as television sets, mobile phones, tablets, computers, etc.) are arranged in distribution layers/levels in relation to the streaming source 12. Thus, two peers are arranged at distribution level 1 one hop away from the streaming source, i.e. the level closest to streaming source, four peers are arranged at distribution level 2 (two hops away from the source) and eight peers are arranged at distribution level 3 (three hops away from the source). To illustrate, the streaming source distributes data content to peer P1, which in its turn distributes the data content to peers P3 and P4. Finally, peer P3 distributes the given data content to both peers P7 and P8, while peer P4 distributed the data content to peers P9 and P10.

Hence, in such a prior art P2P live streaming network, each peer entering the network will ask a device known as a tracker (not shown) for the latest piece of data content to start streaming from as well as k randomly selected peers to be its neighbours. Then, the entering peer will turn to its neighbours for the latest piece of data content, and if it finds the required data content on any neighbouring peer, it will start streaming from that neighbouring peer. Due to network delay and asynchronicity, the entering peer will be delayed by at least the full duration of one piece of data content from its uploader and at least twice that from the streaming source on condition that the entering peer's uploader is delayed by at least the full duration of one piece of data content from the source. In other words, with respect to a real-time playback point of the data content distributed by the streaming source, the entering peer will have a latency of at least two pieces of data content, while its uploader will have a latency of at least one piece of data content. If the entering peer cannot find the latest piece of data content on one of its neighbouring peers, it will download it from the streaming source. As compared to a traditional client-server network, where the server distributes content to all clients in the network, savings in streaming source load of the P2P network in FIG. 3 is 12/14=0.86. That is, instead of streaming content to all 14 peers, the streaming source streams content to two of the peers, which in their turn unload the source by streaming content to the remaining 12 peers, at the expense of network latency.

Now, with reference to that discussed in connection to the timing diagram of FIG. 2, the RT server 11 initiates distribution of content in step S101 to the peer 12 in the P2P network 10 by instructing the streaming source 19 accordingly. The distribution of content is specified by a set of distribution parameters determined the RT server 11. In this particular embodiment a live streaming event is initiated by specifying quality (full HD or standard HD), bit rate (1.8 Mbps or 0.8 Mbps) and maximum number of hops from the streaming source allowed for any peer.

In the second step S102, the RT server 11 acquires from the peer 12 at least one metric associated with the content received by the peer 12. In this particular embodiment, the peer 12 reports to the RT server 11 whether it has downloaded the distributed content from the streaming source or from a neighbouring peer. In that way (by receiving the metric from a great number of network peers) it is possible for the RT server 11 to evaluate the P2P network performance in terms of streaming source bandwidth savings.

Thus, the RT server 11 evaluates in step S103 the performance of the P2P network 10 based on the acquired one or more metrics from the peer 12. In this particular embodiment, the RT server 11 advantageously acquires information regarding from where the respective peer has uploaded the content, and determines bandwidth savings as discussed in connection to FIG. 3.

In the scenario illustrated in FIG. 3, the streaming source bandwidth savings are 12/14=0.86. The RT server 11 can thus assess the P2P network performance resulting from the distribution parameters initially supplied to the streaming source 19 for distributing the content to the peer 12. If this particular exemplifying bandwidth savings measure is satisfactory, the set of distribution parameters initially supplied to the streaming source 19 in step S101 is used by the streaming source 19 for distributing content. This could optionally include a step of the RT server 11 informing the streaming source 19 that the previously supplied set of distribution parameters is to be used by the streaming source 19 for subsequent content distribution to the P2P network peers 12-18. It is important to note that FIG. 3 is used for illustrative purposes only. It is well understand that in a real P2P streaming scenario the number of peers will change over time and so will the structure of the overlay. The timing of peers joining and leaving the P2P network can be controlled by the RT server.

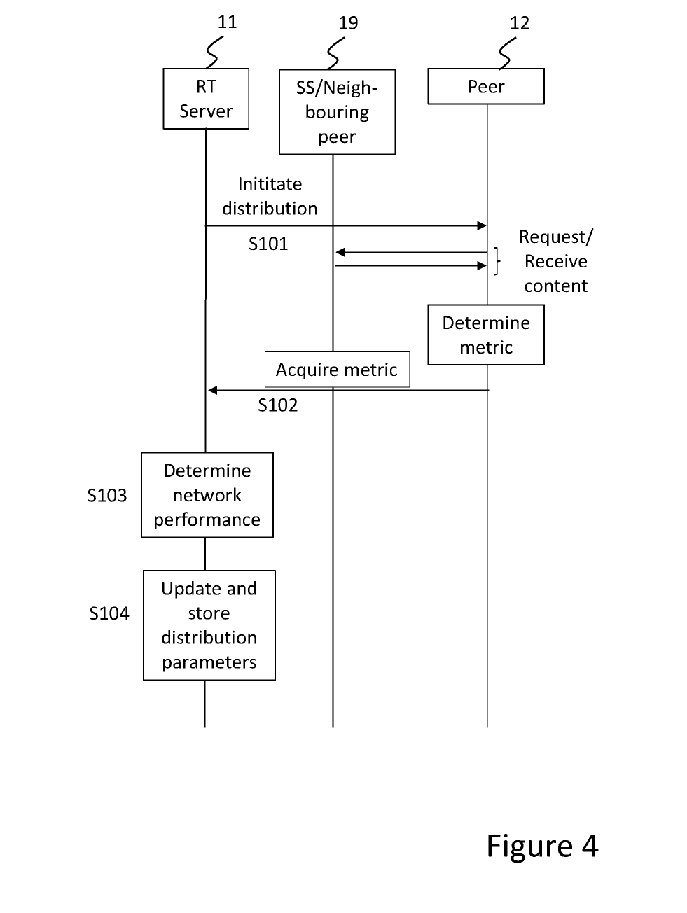

FIG. 4 shows a timing diagram illustrating a further embodiment of the present invention, where on the basis of the determined P2P network performance, the set of distribution parameters should be slightly modified to affect the P2P network performance in line with for instance an operator's requirements. That is, if after the RT server 11 has determined the P2P network performance in step S103, and come to the conclusion that the performance is not as desired in line with e.g. the operator's requirements, a modified set of parameters is advantageously created by the RT server 11 in step S104 and stored at the RT server 11 for future use.

It should be noted that the modified set of parameters alternatively could be stored remote from the RT server 11, such as in a network storage or even distributed over a plurality of nodes in a cloud environment. If the determined P2P network performance is close to the desired performance, the set of parameters may be just slightly modified in step S104 without any further rounds of acquiring metrics from the peer 12.

For instance, assuming that the streaming source bandwidth savings should be slightly increased on the basis of the operator's requirements, the parameter pertaining to the maximum allowed number of distribution levels (i.e. the number of hops from the streaming source) in the network may be increased by one, or the maximum allowed streaming rate may be reduced.

Alternatively, assuming that the latency of the content rendering, with respect to a live content real-time playback point, at a peer located furthest downstream in the network (i.e. peers P7-P14 in FIG. 3) should be slightly decreased, the maximum allowed number of distribution levels in the network may be decreased by one.

Again, the modifying of the at least one distribution parameter based on the determined performance of the P2P network in step S104 may be performed by taking into account metrics associated with the content received by the peer 12 only, or by further taking into account metrics associated with the content transmitted by the streaming source 19 or a neighbouring peer 13.

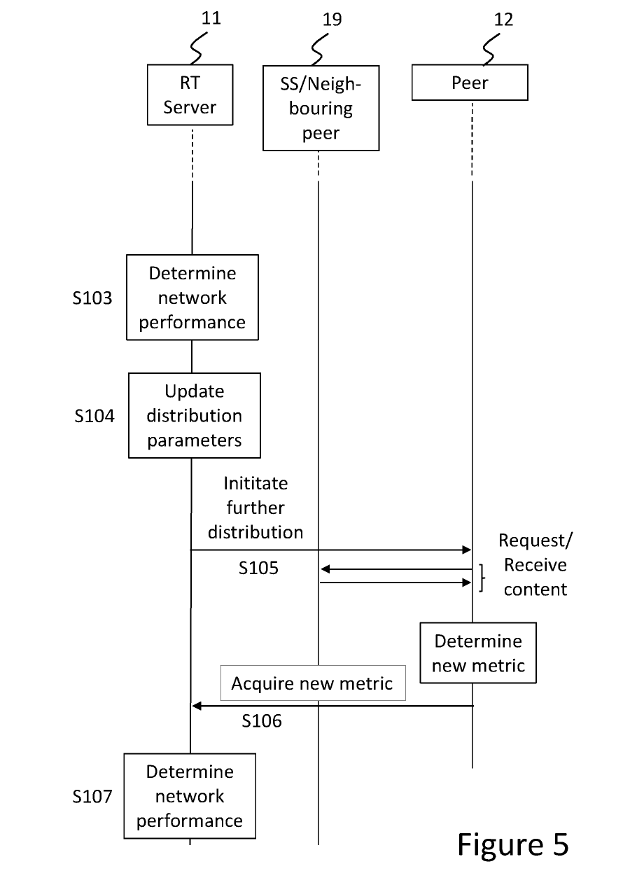

FIG. 5 shows a timing diagram illustrating yet a further embodiment of the present invention, where on the basis of the determined P2P network performance, a further round of distributing content is initiated with the aim to affect, and ultimately optimize, the performance in line with for instance an operator's requirements on the P2P network performance. That is, if after the RT server 11 has determined the P2P network performance in step S103, and come to the conclusion that the performance is not as desired in line with e.g. the operator's requirements, a modified set of parameters is advantageously created by the RT server 11 in step S104. If the determined P2P network performance greatly deviates from that of the desired performance, the set of parameters may be substantially modified in step S104 and submitted to peer 12 in step S105 for initiating a further round of content distribution to the peer 12 specified by the modified set of parameters. The peer 12 will thus request and receive the content from the streaming source 19 or any one of the neighbouring peers 13-18 based on the modified set of parameters. In practice, the modified set of parameters my be distributed to all peers in the network as well as to the streaming source, since the network peers are likely to engage in uploading and/or downloading of content, and thus will conform with the set of distribution parameters in order to attain a desired performance.

For instance, assuming that the streaming source bandwidth savings should be substantially increased on the basis of the operator's requirements, the parameter pertaining to the maximum allowed number of distribution levels in the network may be increased by a greater number than one, and even further parameters in the set may be modified, if required, such as e.g. the bit rate of the standard HD distribution and the full HD distribution or even a parameter stipulating a completely different content to be distributed.

Similar to the embodiment of the present invention described with reference to FIG. 2, the RT server 11 acquires from the peer 12 in a further step S106 at least one metric associated with the content received by the peer 12, the content being specified by the modified set of distribution parameters, in this particular example specifying whether the uploader is a neighbouring peer or the streaming source 19.

In step S107, the RT server 11 determines the performance of the P2P network 10 based on the new acquired metric from the peer 12. If the performance is considered to be as desired, the RT server 11 advantageously concludes that the modified set of parameters should be used by the streaming source 19 or neighbouring peers 13-18 for subsequent content distribution. If not, another round of modifying the distribution parameters will be undertaken. By initiating a plurality of rounds of content distribution based on carefully selected distribution parameters and acquiring resulting metrics from the peers, the performance of the P2P network can advantageously be increased or even optimized.

It should be noted that in order for the peers 12-18 to be able to report desired metrics to the RT server 11, it may be necessary to equip the peers with an appropriate content rendering element, e.g., by installing an appropriate piece of software at the respective peer 12-18, which can mimic the behaviour of a peer device media player rendering the received content, unless the measuring and reporting of the metric(s) in fact are performed by the peer during a “normal” content distribution as specified by distribution parameters supplied by the RT server 11. However, in any case, the peer devices 12-18 may have to be equipped with the appropriate software functionality for being able to report adequately to the RT server 11. The peer devices 12-18 of the P2P network 10 may further be capable of communication with each other in order to procure desired metrics for reporting to the RT server 11.

Further, the metric reports acquired by the RT server 11 from the peers 12-18 may be complemented by the streaming source 19 reporting one or more properties to the RT server 11 such that the P2P network performance can be determined, e.g. number of bytes uploaded, failed connections, interrupted streams, etc.

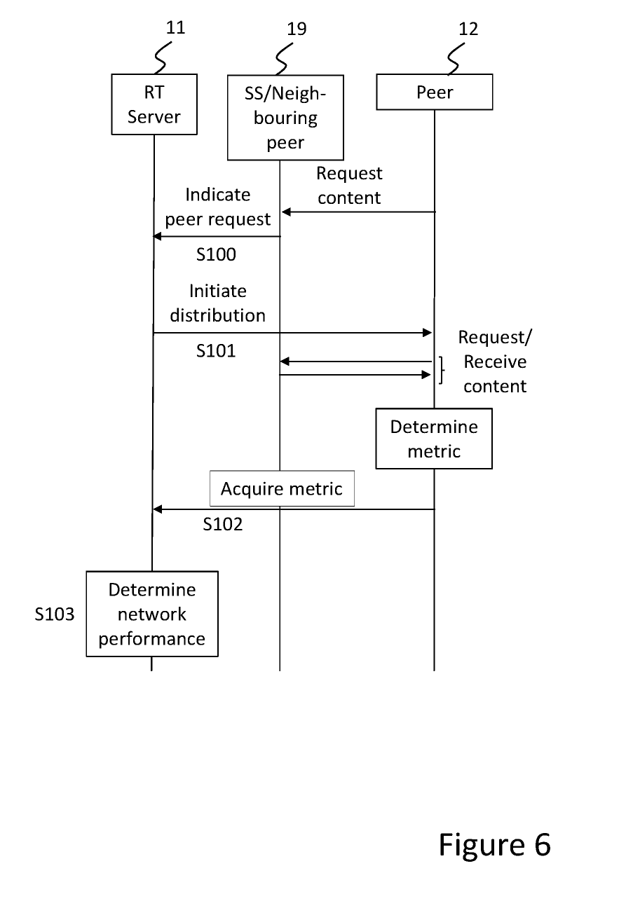

FIG. 6 shows a timing diagram illustrating still a further embodiment of the present invention, where the determining of the P2P network performance undertaken by the RT server 11 is performed as part of a “normal” content distribution procedure in the P2P network. Typically, each of the peers 12-18 request content and is either supplied content from the streaming source 19 or more commonly, given the nature of a P2P system, from one or more neighbouring peers.

In step S100, the RT server 11 receives an indication from the streaming source 19 or a neighbouring peer 13-18 that one or more requests for content is received from the peer 12. Alternatively, the request is received directly from the peer(s) which desires to download content. As in the embodiments of the invention described with reference to the previous timing diagrams, the RT server 11 initiates in step S101 distribution of the requested content to the peer 12 in the P2P network 10 by signalling accordingly to the peer 12, the distribution of content again being specified by the set of distribution parameters determined the RT server 11. The streaming source 19 or neighbouring peer 13-18 subsequently distributes the requested content to the peer 12 as specified by the distribution parameters submitted by the RT server 11.

In a second step S102, the RT server 11 acquires from the peer 12 at least one metric associated with the content received by the peer 12 and determines in step S103 the performance of the P2P network 10 based on the acquired one or more metrics from the peer 12, as previously has been described in detail.

Moreover, even though the timing diagrams in FIGS. 2, 4 and 5 illustrate reporting of metrics of a single peer 12 to the RT server 11, a great number of peers will in practice be utilized for the metrics reporting, and the RT server 11 will aggregate the reported metrics in order to determine the P2P network performance. Aggregated metrics may include, in addition to the previously mentioned exemplifying metrics, playback quality (i.e. what percentage of peers on average watched the highest quality video with the highest bit rates as compared to a second highest quality, switching frequency (i.e. how often peers switch between different quality streams), etc.

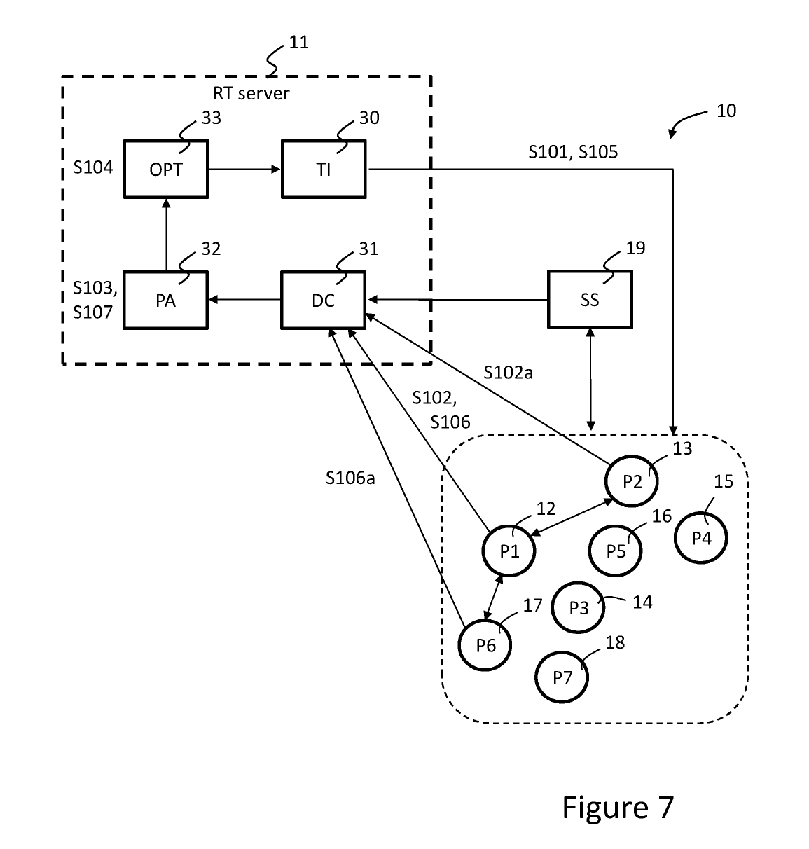

FIG. 7 illustrates the RT server 11 in more functional detail. Again, as was discussed with reference to FIG. 1, functions of the RT server are typically embodied by a processing unit in the form of one or more microprocessors arranged to execute a computer program downloaded to a suitable storage medium associated with the microprocessor. The processing unit may alternatively be embodied in the form of a DSP, an ASIC, an FPGA, a CPLD, etc.

A Test Initiator (TI) 30 of the RT server 11 determines that performance of the network 10 is to be improved, or even optimized, with respect to one or more network performance aspects, such as for instance:
1) Minimize streaming source(s) bandwidth consumption,
2) Minimize live streaming latency,
3) Maximize locality (i.e. keeping network traffic local), or
4) Maximize Quality of Service (QoS).

The TI 30 will thus select a subset of the peer devices 12-18 to be included in the test, and initiate distribution of content in step S101 to the subset of peers, in this case exemplified by the single peer 12. Typically, hundreds or even thousands of peer devices may be included in the network 10, while some ten or twenty will be included in the subset to be tested.

The distribution of content is specified by at least one distribution parameter controlling the performance. Assuming for instance that task 2) hereinabove is a performance aspect to be optimized: live streaming latency is to be minimized.

The distribution parameter controlling the performance may thus be embodied by a locality parameter. That is, the peer 12 is to turn to another peer or the streaming source 19 considering the locality parameter and thus select a content distributor resulting in low latency. Additionally or alternatively, the distribution parameter may for instance indicate type of content to be distributed, for instance whether the distributed content is audio and/or video, which may have an impact on the subsequently determined latency.

As an example, assuming that a first peer 13 is located closer to downloading peer 12 as compared to a second peer 14 or the streaming source 19. The downloading peer 12 will thus consider the distribution parameter (“locality”) and turn to the first peer 13, even if the first peer 13, e.g., would provide a lower QoS than the second peer 14 upon the downloading peer 12 rendering the live content streams.

In step S102, a Data Collection (DC) back-end 31 of the RT server 11 acquires, from the downloading peer device 12, at least one metric associated with the content received. For instance, since live streaming latency is to be minimized under 2), the metric associated with the received content may be embodied in the form of a timestamp T1 indicating an instant of time when the requested content is received (or even when it is rendered by the downloading peer device 12 should there be a non-negligible time difference between the instant of receiving the content and the instant of rendering the received content).

Further in step S102a, the DC back-end 31 of the RT server 11 acquires, from the uploading first peer device 13, at least one metric associated with the content transmitted. In this example, a timestamp T2 indicating an instant of time when the very same content was made available at the streaming source 19. Assuming that a live sports event is streamed; the latency to be determined is thus the difference between the instant when an action takes place in real time and the instant when the same action in fact is rendered by a peer device (in practice typically coinciding with the instant in time when the content is received). For instance, this latency may be exemplified as the difference between the (real) time when a football striker scores a goal and the time when a viewer actually sees it happen on his or her screen.

These two metrics—i.e. timestamps T1 and T2—are passed on to a Performance Analyser (PA) 32 of the RT server 11 which determines in step 103 the performance of the network in accordance with the performance aspect under test. In this particular embodiment, the performance—exemplified by live streaming latency—is determined as:

Latency=T1−T2.

Now, if the PA 32 determines in step S103 that the latency is minimized (or at last good enough), the test is terminated by an Optimal Parameter Tuner 33 of the RT server 11, and it may advantageously be determined for instance that the downloading peer 12 and a number of neighbouring peers being proximate to the downloading peer 12 (for instance being located in a same district or geographical area of a city) is to download content from the second peer device 13.

If not, the OPT 33 will in step S104 modify the at least one distribution parameter based on the determined performance of the P2P network 10, such that the modified at least one distribution parameter is configured to control performance of the P2P network according to P2P network performance requirements and inform the TI 30 accordingly.

In this example, the locality parameter is modified such that the TI 30 initiates another round of distribution of content in step S106 to the downloading peer 12, where the downloading peer 12 attempts to request content from a third peer device 17 providing a decreased live streaming latency as compared to the first peer device 13.

Hence, in step S106, the DC back-end 31 of the RT server 11 acquires, from the downloading peer device 12, the metric associated with the content received in the form of a timestamp T3 indicating an instant of time when the requested content is received from the third peer device 17 (or when the requested content actually is rendered at the downloading peer device 12 as previously discussed).

Further in step S106a, the DC back-end 31 of the RT server 11 acquires, from the uploading third peer device 17, at least one metric associated with the content transmitted. In this example, a timestamp T4 indicating an instant of time when the requested content was made available at the streaming source 19 is acquired. It should be noted that timestamp T4 previously has been provided to the uploading third peer device 17, either from the streaming source 19 itself or via any other peer device uploading the requested content to the third peer device 17.

These two metrics—i.e. timestamps T3 and T4—are passed on to the PA 32 of the RT server 11 which determines in step 107 the performance of the network in accordance with the performance aspect under test. Again, in this particular embodiment, the performance—exemplified by live streaming latency—is determined as:

Latency=T3−T4.

Again, if the PA 32 determines in step S107 that the latency is minimized (or at last good enough), the test is terminated by the OPT 33 of the RT server 11, and it may advantageously be determined for instance that the downloading peer 12 and a number of neighbouring peers being proximate to the downloading peer 12 (for instance being located in a same district or geographical area of a city) is to download content from the third peer device 17.

It should be noted that in an embodiment where only the downloading peer device 12, and not the streaming source 19 or any other uploading peer device 13, reports metrics to the RT server 11 as previously has been described, either the streaming source 19 or any uploading peer device 13 may provide the downloading peer device 12 with a metric associated with the content transmitted to the peer device 12. For instance, in case of optimizing performance of the P2P network with respect to latency as described with reference to FIG. 7, the timestamp T2 (and T4 in case of an iterative behaviour) must be reported to the downloading peer device 12 from the streaming source 19 or any uploading peer 13, such that the RT server 11 may determine the latency.

With regards to selecting one or more peer devices to which distribution of content is to be initiated, and from which one or more metrics are to be acquired, a number of embodiments are envisaged.

In the following, a number of peer device selection strategies are envisaged:

1. No selection of peer devices is undertaken; distribution of content is initiated to all available peers.
2. Distribution of content is initiated for a number of peer devices in a network segment corresponding to an expected number of actual viewers, where a segment/site is embodied for instance in the form of a district or geographical area of a city, a particular building, a particular enterprise spread over a number of physical offices, etc.
3. Proportional with respect to size of a segment/site size, where the number of peer devices (randomly) selected from each site/network segment is set to be proportional to the expected number of viewers in that segment. For example, if network segment A has an expected number of viewers of 10000 and segment B has 50000; a test run may specify a proportion of 10%, and include 1000 peer devices from segment A and 5000 peer devices from segment B.
4. Proportional with respect to client type. Thus, the selection takes into account peer device hardware, operating system, memory and bandwidth capacity, etc. Then, peer devices are selected in proportion to expected client type in a live streaming scenario.

A combination of one or more of the above listed strategies can further be envisaged.

The invention has mainly been described above with reference to a few embodiments. However, as is readily appreciated by a person skilled in the art, other embodiments than the ones disclosed above are equally possible within the scope of the invention, as defined by the appended patent claims.

1. A method of determining performance of a peer-to-peer, P2P, network comprising a plurality of peer devices, the method comprising:
initiating distribution of content to at least one of the plurality of peer devices in the P2P network, the distribution of content being specified by at least one distribution parameter;
acquiring, from said at least one peer device, at least one metric associated with the content received by the at least one peer device; and
determining the performance of the P2P network based on the acquired at least one metric.

2. The method according to claim 1, further comprising:
modifying the at least one distribution parameter based on the determined performance of the P2P network, such that said modified at least one distribution parameter is configured to control performance of the P2P network according to P2P network performance requirements.

3. The method according to claim 2, further comprising:
initiating further distribution of content to the at least one of the plurality of peer devices in the P2P network, the further distribution of content being specified by the modified at least one distribution parameter;
acquiring, from said at least one peer device, at least one metric associated with the further content received by the at least one peer device; and
determining the performance of the P2P network based on the acquired at least one metric associated with the further received content.

4. The method according to claim 1, further comprising:
receiving an indication that the at least one of the plurality of peer devices in the P2P network requests the content.

5. The method according to claim 1, wherein the at least one distribution parameter comprises one or more of:
type of distributed content, quality of the distributed content, bit rate of the distributed content, a download locality parameter specifying likelihood that a network peer will download the content from a neighbouring network peer, or maximum number of allowed hops of the network peer devices from the content distributor.

6. The method according to claim 1, wherein the at least one metric comprises one or more of:
amount of the content downloaded from the content distributor versus amount of the content downloaded from a neighbouring network peer device in the P2P network, network locality of the neighbouring peer device uploading the content, content playback quality, number of failed content uploads, number of failed content downloads, number of hops away from the content distributor, or playback point at the at least one peer device with respect to real-time playback point of the content distribution.

7. The method according to claim 1, wherein the initiating of distribution of content comprises:
instructing the at least one peer device to request the content from a distributor of the content.

8. The method according to claim 1, further comprising:
acquiring, from a distributor of the content, at least one metric associated with the content transmitted by said distributor of the content;
wherein the determining of the performance of the P2P network further comprises:
determining the performance of the P2P network further based on the acquired at least one metric associated with the content transmitted.

9. The method according to claim 3, further comprising:
acquiring, from a distributor of the content, at least one metric associated with the further content transmitted by said distributor;
wherein the determining of the performance of the P2P network further comprises:
determining the performance of the P2P network further based on the acquired at least one metric associated with the further content transmitted.

10. The method according to claim 8, the at least one metric associated with the content received by the at least one peer device indicating the instant of time when said content is received, and the at least one metric associated with the content transmitted by said distributor of the content indicating an instant of time when said content was made available at the source of the content, wherein the performance of the P2P network is determined based on latency.

11. The method according to claim 1, the at least one metric associated with the content received by the at least one peer device indicating a latency between an instant of time when said content was made available at a source of the content and an instant of time when said content is received at the at least one peer device, wherein the performance of the P2P network is determined based on said latency.

12. A device configured to determine performance of a peer-to-peer, P2P, network comprising a plurality of peer devices, the device comprising a processing unit being arranged to execute instructions, wherein the device is configured to:
initiate distribution of content to at least one of the plurality of peer devices in the P2P network, the distribution of content being specified by at least one distribution parameter;
acquire, from said at least one peer device, at least one metric associated with the content received by the at least one peer device; and
determine the performance of the P2P network based on the acquired at least one metric.

13. The device of claim 12, further configured to:
modify the at least one distribution parameter based on the determined performance of the P2P network, such that said modified at least one distribution parameter is configured to control performance of the P2P network according to P2P network performance requirements.

14. The device of claim 13, further configured to:
initiate further distribution of content to the at least one of the plurality of peer devices in the P2P network, the further distribution of content being specified by the modified at least one distribution parameter;
acquire, from said at least one peer device, at least one metric associated with the further content received by the at least one peer device; and
determine the performance of the P2P network based on the acquired at least one metric associated with the further content.

15. The device according to claim 12, further configured to:
receive an indication that the at least one of the plurality of peer devices in the P2P network requests the content.

16. The device according to claim 12, further configured to:
acquire, from a distributor of the content, at least one metric associated with the content transmitted by said distributor of the content; and
determine the performance of the P2P network further based on the acquired at least one metric associated with the content transmitted.

17. The device according to claim 14, further configured to:
acquire, from a distributor of the content, at least one metric associated with the further content transmitted by said distributor; and
determine the performance of the P2P network further based on the acquired at least one metric associated with the further content transmitted.

18. The device according to claim 16, the at least one metric associated with the content received by the at least one peer device indicating the instant of time when said content is received, and the at least one metric associated with the content transmitted by said distributor of the content indicating an instant of time when said content was made available at the source of the content, wherein the performance of the P2P network is determined based on said latency.

19. The device according to claim 12, the at least one metric associated with the content received by the at least one peer device indicating a latency between an instant of time when said content was made available at a source of the content and an instant of time when said content is received at the at least one peer device, wherein the performance of the P2P network is determined based on latency.

20. A computer program configured comprising computer-executable instructions for causing a device to perform the method of claim 1 when the computer-executable instructions are executed on a processing unit included in the device.

21. A computer program product comprising a computer readable medium configured, the computer readable medium having the computer program configured according to claim 20 embodied therein.

22. A system configured to determine performance of a peer-to-peer, P2P, network comprising a plurality of peer devices, the system comprising at least one processing unit being arranged to execute instructions, whereby the system is configured to:
initiate distribution of content to at least one of the plurality of peer devices in the P2P network, the distribution of content being specified by at least one distribution parameter;
acquire, from said at least one peer device, at least one metric associated with the content received by the at least one peer device; and
determine the performance of the P2P network based on the acquired at least one metric.
